(19) United States
(12) Patent Application Publication
(10) Pub. No.: US 2022/0014292 A1
(43) Pub. Date: Jan. 13, 2022

(54) DISPLAY DEVICE AND METHOD FOR CONTROLLING SAME

(71) Applicant: Samsung Electronics Co., Ltd., Suwon-si, Gyeonggi-do (KR)

(72) Inventor: Sangha CHOI, Suwon-si (KR)

(73) Assignee: Samsung Electronics Co., Ltd., Suwon-si, Gyeonggi-do (KR)

(21) Appl. No.: 17/293,628

(22) PCT Filed: Dec. 19, 2019
(86) PCT No.: PCT/KR2019/018055

§ 371 Date: May 13, 2021

(30) Foreign Application Priority Data
Dec. 20, 2018 (KR) 10-2018-0166494

(51) Int. Cl. H04H 60/40; H04H 60/37; H04N 21/434; H04N 21/435; H04N 21/458

(52) U.S. Cl. CPC H04H 60/40; H04H 60/372; H04N 21/4583; H04N 21/4345; H04N 21/435; H04H 60/375

(57) ABSTRACT

Disclosed is a display apparatus including: a receiver; a communicator; a display; and a processor configured to: obtain first media information and a service app from a broadcast signal received through the receiver, receive second media information corresponding to the first media information from a server through the communicator by executing the obtained service app, identify a different schedule section based on comparison in between content schedule of the first media information and content schedule of the second media information, and perform an operation convenient for a user to use the broadcast program, based on the identified schedule section.

### TECHNICAL FIELD

The disclosure relates to a display apparatus and a control method thereof, and more particularly to a display apparatus based on advanced television systems committee (ATSC) 3.0 and a control method thereof.

### BACKGROUND ART

Through a program guide, a user of a television (TV) can check start and end times of broadcast programs.

However, at a start time of a broadcast program based on the program guide, a commercial is often broadcasted instead of the broadcast program. Therefore, it is highly likely to watch a commercial for a substantial amount of time even when it is desired to watch a predetermined broadcast program based on broadcast start-time information provided by the program guide. To avoid watching the commercial, a user inconveniently has to change a channel, watch another broadcast program for a while, return back to the corresponding broadcast program, and check whether the broadcast program actually starts.

Such a problem still persists even under new broadcasting standards, i.e., advanced television systems committee (ATSC) 3.0. Under the ATSC 3.0, a broadcasting company provides schedules of broadcast programs through electronic service guide (ESG) information, but the ESG information does not include information about schedules of commercials. Because the schedules of the commercials are not informed, the foregoing inconvenience for users still remains.

### Technical Problem

Accordingly, an aspect of the disclosure is to provide a display apparatus improved in convenience for a user.

### Technical Solution

According to an embodiment of the disclosure, there is provided a display apparatus including: a receiver; a communicator; a display; and a processor configured to: obtain first media information and a service app from a broadcast signal received through the receiver, receive second media information corresponding to the first media information from a server through the communicator by executing the obtained service app, identify a different schedule section based on comparison in between content schedule of the first media information and content schedule of the second media information, and perform an operation convenient for a user to use the broadcast program, based on the identified schedule section.

The first media information and the second media information may include a media presentation descriptor (MPD).

The processor may be configured to obtain schedule information of service content about a broadcast program to be provided from the broadcast signal, based on the identified schedule section.

The processor may be configured to obtain the schedule information of the service content by comparing the MPD of the first media information and the MPD of the second media information in units of period.

The processor may be configured to obtain the schedule information of the service content based on comparison in a media tag of a segment included in the period.

The processor may be configured to identify a broadcast start time of a broadcast program provided after the service content is ended, based on the obtained schedule information of the service content, and perform the operation convenient for a user based on the identified broadcast start time.

The processor may be configured to receive a user's input for making a schedule to watch the broadcast program, and display an alert message to the user on the display based on the identified broadcast start time.

The processor may be configured to receive a user's input for making a schedule to record the broadcast program, switch the display apparatus over from a sleep mode to a recording mode based on the identified broadcast start time, and perform a recording operation for the broadcast program.

The processor may be configured to perform scheduled recording for the broadcast program except the service content, based on a user's input for making a schedule to record the broadcast program.

The processor may be configured to display customized content for a user of the display apparatus by replacing the service content based on the obtained schedule information of the service content.

According to an embodiment of the disclosure, there is provided a method of controlling a display apparatus, comprising: obtaining first media information and a service app from a broadcast signal received through a receiver; receiving second media information corresponding to the first media information from a server through a communicator by executing the obtained service app; identifying a different schedule section based on comparison in between content schedule of the first media information and content schedule of the second media information; and performing an operation convenient for a user to use the broadcast program, based on the identified schedule section.

The first media information and the second media information may include a media presentation descriptor (MPD).

The control method may further include obtaining schedule information of service content about a broadcast program to be provided from the broadcast signal, based on the identified schedule section.

The obtaining the schedule information may include obtaining the schedule information of the service content by comparing the MPD of the first media information and the MPD of the second media information in units of period.

The performing the operation convenient for a user may include identifying a broadcast start time of a broadcast program provided after the service content is ended, based on the obtained schedule information of the service content, and performing the operation convenient for a user based on the identified broadcast start time.

The performing the operation convenient for a user may include receiving a user's input for making a schedule to watch the broadcast program, and displaying an alert message to the user on the display based on the identified broadcast start time.

The performing the operation convenient for a user may include receiving a user's input for making a schedule to record the broadcast program, switching the display apparatus over from a sleep mode to a recording mode based on the identified broadcast start time, and performing a recording operation for the broadcast program.

The performing the operation convenient for a user may include performing scheduled recording for the broadcast program except the service content, based on a user's input for making a schedule to record the broadcast program.

The performing the operation convenient for a user may include displaying customized content for a user of the display apparatus by replacing the service content based on the obtained schedule information of the service content.

According to an embodiment of the disclosure, there is provided a computer program stored in a medium to carry out the foregoing control method as combined to a display apparatus.

The computer program may be stored in a medium of a server and downloaded in the display apparatus through a network.

### Advantageous Effects

As described above, according to the disclosure, a display apparatus is improved in convenience for a user.

### DESCRIPTION OF DRAWINGS

FIG. 1 illustrates a display apparatus according to an embodiment of the disclosure,

FIG. 2 is a block diagram showing a display apparatus according to an embodiment of the disclosure,

FIG. 3 is a flowchart of showing operations of a display apparatus according to an embodiment of the disclosure,

FIG. 4 is a block diagram showing a protocol stack based on advanced television systems committee (ATSC) 3.0, i.e., standards for a broadcast signal transmitted to a display apparatus according to an embodiment of the disclosure,

FIG. 5 illustrates a relationship between an electronic service guide (ESG) and a media presentation descriptor (MPD),

FIG. 6 illustrates a structure of an MPD,

FIG. 7 illustrates a process of generating a replacement MPD from an original MPD by a display apparatus according to an embodiment of the disclosure,

FIG. 8 is a schematic operation view of an AD insertion app in a display apparatus according to an embodiment of the disclosure,

FIGS. 9 to 12 illustrate examples of an original MPD and a replacement MPD,

FIG. 13 illustrates a playback sequence or a playback flow of content based on media information of an original MPD and a replacement MPD,

FIGS. 14 to 18 show effects of a display apparatus according to an embodiment of the disclosure as compared with the related art, and

FIGS. 19 to 22 illustrate various examples of operations convenient for a user in a display apparatus according to an embodiment of the disclosure.

### BEST MODE

Below, exemplary embodiments will be described in detail with reference to accompanying drawings. In the drawings, like numerals or symbols refer to like elements having substantially the same function, and the size of each element may be exaggerated for clarity and convenience of description. However, the configurations and functions illustrated in the following exemplary embodiments are not construed as limiting the present inventive concept and the key configurations and functions. The embodiments described with reference to the drawings are not exclusive to each other uncles otherwise noted, but a plurality of embodiments may be selectively combined and implemented. In the following descriptions, details about publicly known functions or features will be omitted if it is determined that they cloud the gist of the present inventive concept.

In the following exemplary embodiments, terms ‘first’, ‘second’, etc. are only used to distinguish one element from another, and singular forms are intended to include plural forms unless otherwise mentioned contextually. In the following exemplary embodiments, it will be understood that terms ‘comprise’, ‘include’, ‘have’, etc. do not preclude the presence or addition of one or more other features, numbers, steps, operations, elements, components or combination thereof. In addition, a ‘module’ or a ‘portion’ may perform at least one function or operation, be achieved by hardware, software or combination of hardware and software, and be modularized into at least one processor. Further, in the following exemplary embodiments, at least one among a plurality of elements refer to not only all of the plurality of elements but also each element among the plurality of elements excluding the other elements or a combination thereof. Further, the expression of “configured to (or set to)” may for example be replaced with “suitable for,” “having the capacity to,” “designed to,” “adapted to,” “made to,” or “capable of” according to circumstances. Also, the expression of “configured to (or set to)” may not necessarily refer to only “specifically designed to” in terms of hardware. Instead, the “device configured to” may refer to “capable of” along with other devices or parts in a certain circumstance. For example, the phrase of “the processor configured to perform A, B, and C” may refer to a dedicated processor (e.g., an embedded processor) for performing the corresponding operations, or a generic-purpose processor (e.g., a central processing unit (CPU) or an application processor) for performing the corresponding operations by executing one or more software programs stored in a memory device.

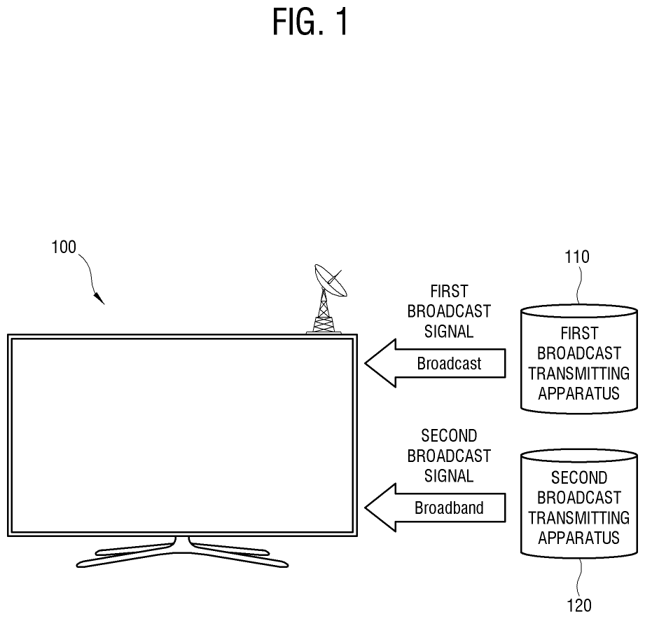

FIG. 1 illustrates a display apparatus according to an embodiment of the disclosure. The display apparatus 100 according to an embodiment of the disclosure may for example be embodied by a television (TV). Further, the display apparatus 100 according to another embodiment of the disclosure may for example be embodied by an electronic frame, a digital billboard, a large format display (LFD), a digital signage, a smartphone, a tablet computer, a mobile phone, a smartwatch, a head-mounted display or the like wearable device, a computer, a multimedia player, a set-top box, a smart refrigerator, or the like apparatus capable of outputting an image based on content. However, the display apparatus 100 according to an embodiment of the disclosure is not limited to these examples, but may include any apparatus capable of displaying an image. Further, the disclosure may be applicable to a broadcast receiving apparatus excluding a display 230. In other words, the disclosure may be embodied by any apparatus capable of receiving and processing a broadcast signal even though the apparatus does not directly display an image. Below, for convenience of description, the disclosure is embodied by the display apparatus 100.

The display apparatus 100 may receive a first broadcast signal from a first broadcast transmitting apparatus 110 by a broadcast mode, or may receive a second broadcast signal from a second broadcast transmitting apparatus 120 by a broadband mode. The first broadcast transmitting apparatus 110 may include a terrestrial transmitter of a certain broadcasting station, and the second broadcast transmitting apparatus 120 may include a network server connected to the Internet. Although there is a difference between the broadcast mode and the broadband mode, both the first broadcast transmitting apparatus 110 and the second broadcast transmitting apparatus 120 in this embodiment can transmit a broadcast signal based on advanced television systems committee (ATSC) 3.0.

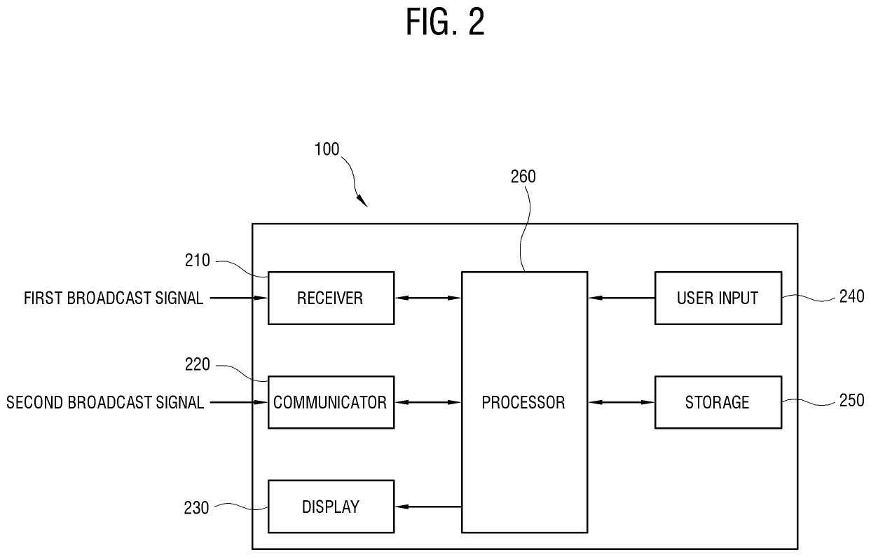

FIG. 2 is a block diagram of a display apparatus according to an embodiment of the disclosure. The display apparatus 100 according to an embodiment of the disclosure includes a receiver 210 configured to receive the first broadcast signal, a communicator 220 configured to receive the second broadcast signal, a display 230 configured to display an image of a broadcast service, a user input 240 configured to receive a user's input, a storage 250 configured to store data, and a processor 260 configured to process the first broadcast signal or the second broadcast signal so that the image of the broadcast service can be displayed. However, the configuration of the display apparatus 100 shown in FIG. 2 is merely an example, and the display apparatus 100 according to an embodiment of the disclosure may be embodied to have another configuration. In other words, the display apparatus according to an embodiment of the disclosure may be embodied including other elements in addition to the elements shown in FIG. 2, or excluding some elements shown in FIG. 2. According to an embodiment of the disclosure, the configurations may include at least one of hardware and/or software, and may be embodied by a circuit or a chip.

The receiver 210 includes an antenna or circuit for receiving the first broadcast signal in the broadcast mode, transmitted from the transmitter of the broadcasting station, and a tuner for being tuned to the first broadcast signal. The receiver 210 is tuned to a frequency at which the first broadcast signal is assigned, and transmits the tuned first broadcast signal to the processor 260.

The communicator 220 refers to a communication circuit that includes an input/output interface in which communication modules, ports or the like corresponding to various kinds of communication protocols, to receive the second broadcast signal in the broadband mode, transmitted from the network server. The communicator 220 basically receives the second broadcast signal from the server, but may interactively transmit and receive a signal. The communicator 220 is connected for communication to the server through various wired or wireless networks such as a local area network (LAN), Wi-Fi, etc.

The display 230 includes a display panel capable of displaying an image on a screen. The display panel is provided to have a light receiving structure such as a liquid crystal type, or a self-emissive structure such as an organic light emitting diode (OLED) type. The display 230 may include an additional element according to the structures of the display panel. For example, when the display panel is the liquid crystal type, there are added a backlight unit configured to emit light to a liquid crystal display panel, a panel driving substrate configured to drive liquid crystal of the liquid crystal display panel, etc.

The user input 240 transmits a preset control command or information to the processor 260 in response to a user's control or input. The user input 240 may be variously embodied according to methods of inputting information. For example, the user input 240 may include a key provided at an outer side of the display apparatus 100, a touch screen provided in the display 230, a camera or sensor for capturing or sensing a user's gesture or the like, and the like various user interface environments provided in the display apparatus 100. Alternatively, the user input 240 may include a remote controller physically separated from the display apparatus 100.

The storage 250 is accessed by the processor 260, and performs operations such as reading, recording, modifying, deleting, updating, etc. for data under control of the processor 260. The storage 250 includes a flash memory, a hard disk drive (HDD), a solid status drive (SSD), and the like nonvolatile memory in which data is retained regardless of whether the display apparatus is powered on or off; and a buffer, a random access memory (RAM) and the like volatile memory to which processing data is loaded.

The processor 260 processes the first broadcast signal or the second broadcast signal to thereby display an image of a broadcast service on the display 230. The processor 260 extracts many pieces of information for the broadcast service from the tuned broadcast signal, decodes image data based on the extracted information, and outputs the decoded image data to the display 230. The processor 260 includes a hardware processor embodied by a central processing unit (CPU), a chipset, a buffer, a circuit, etc. which are mounted on a printed circuit board (PCB). Alternatively, the processor 260 may be designed as a system on chip (SoC). The processor 260 includes modules corresponding to various processes, such as a demultiplexer, a decoder, a scaler, an audio digital signal processor (DSP), an amplifier, etc., and some among them may be embodied by the SoC. For example, a demultiplexer, a decoder, a scaler, and the like module related to an image process may be achieved as an image processing SoC, and an audio DSP may be achieved as a chipset separated from the SoC.

The processor 260 may perform control to operate general elements of the display apparatus 100. The processor 260 may execute a control program (or instruction) to perform such control operation. In this case, the display apparatus 100 may further include a nonvolatile memory in which the control program is installed, and a volatile memory to which at least a part of the installed control program is loaded. Further, such a control program may be stored in other electronic devices as well as the display apparatus 100.

The control program may include a program(s) embodied by at least one among a basic input/output system (BIOS), a device driver, an operating system, firmware, a platform, and an application program (or an application). According to an embodiment, the application program may be previously installed or stored in the display apparatus 100 when the display apparatus 100 is manufactured, or may be installed in the display apparatus 100 based on data of an application program received from the outside in the future when it is required to be used. The data of the application program may for example be downloaded from an external server such as an application market to the display apparatus 100, but not limited thereto. Meanwhile, the processor 260 may be embodied in the form of a device, a S/W module, a circuit, a chip, etc. or combination thereof. Below, for convenience of description, operations of the processor 260 according to an embodiment of the disclosure, which are performed by executing a control program, may be described as the operations of the processor 260 without mentioning the control program.

The processor 260 may for example control the receiver 210 to receive a first broadcast signal, and the communicator 220 to receive a second broadcast signal. The processor 260 may further perform a process for a broadcast signal and then control the display 203 to display the corresponding image. The display apparatus 100 shown in FIG. 2 is embodied to include a single processor 260 configured to perform both the process and the control, but this is merely an example. According to an alternative embodiment of the disclosure, the display apparatus 100 may be embodied to additionally include a controller separately from the processor 260.

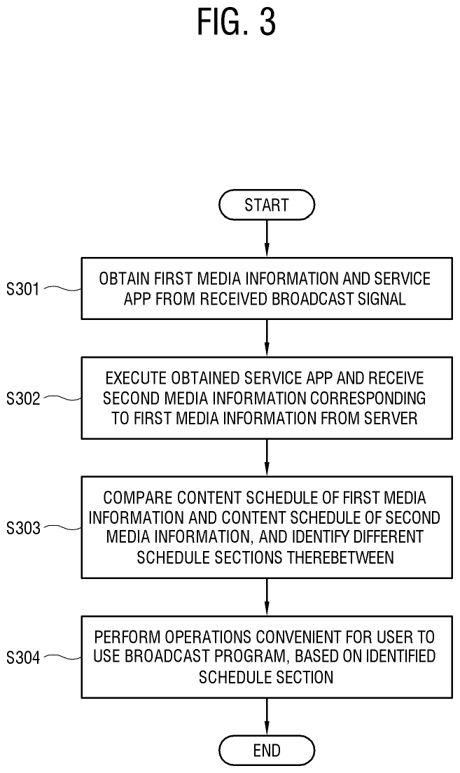

FIG. 3 is a flowchart of showing operations of the display apparatus 100 according to an embodiment of the disclosure.

The processor 260 of the display apparatus 100 according to an embodiment of the disclosure obtains first media information and a service app from a received broadcast signal (S301). Here, the first media information refers to information about media, content or data contained in the broadcast signal transmitted from the first broadcast transmitting apparatus 110 or the second broadcast transmitting apparatus 120. For example, when the broadcast signal is a signal based on ATSC 3.0, the first media information may include information about media processing units (MPU) based on an MPEG Media transport protocol (MMTP), and information about a dynamic adaptive streaming over hypertext transfer protocol (HTTP) (DASH) segment based on a real time object delivery over unidirectional transport (ROUTE) protocol or HTTP protocol. Further, the first media information may include signaling data that contains various pieces of control information. For example, the first media information may include a media presentation descriptor (MPD), i.e., signaling data that contains guide information and/or control information corresponding to content. Details of the MPD will be described later. However, the first media information may include any information without limitations as long as it is information related to a broadcast signal and transmitted to the display apparatus 100. The first media information may be transmitted together with or being embedded in a broadcast signal transmitted to the display apparatus 100, or may be provided or obtained through other channels.

Further, the service app includes a program, an application, software and the like capable of performing a predetermined process based on a broadcast signal or with regard to a broadcast signal transmitted to the display apparatus 100. For example, the service app may include an advertisement (AD) insertion app that changes, replaces or modifies at least part of the MPD by information about advertisement, with regard to the MPD about the broadcast signal transmitted to the display apparatus 100. However, the service app may include any software without limitations as long as it can perform a predetermined process based on the broadcast signal or provide a service based on the process. Detailed operations of the AD insertion app will be described later. The service app may be transmitted together with or being embedded in a broadcast signal transmitted to the display apparatus 100, or may be provided or obtained through other channels.

The processor 260 executes the obtained service app and receives second media information corresponding to first media information from the server (S302). Here, the second media information refers to information generated, obtained or processed as the service app is executed to perform an operation based on the first media information. For example, when the first media information is the MPD and the service app is the AD insertion app, a new MPD is generated as at least part of the MPD is changed, replaced or modified into information about the advertisement by the AD insertion app, in which the newly generated MPD may correspond to the second media information. However, as mentioned above, the first and second media information according to the disclosure are not limited to the MPD, and the service app according to the disclosure is not limited to the AD insertion app. For convenience of description, it will be generally described below on the assumption that the first and second media information are the MPD and the service app is the AD insertion app. Below, the MPD corresponding to the first media information will be called an ‘original MPD,’ and the MPD corresponding to the second media information will be called a ‘replacement MPD.’

The processor 260 compares a content schedule of the first media information and a content schedule of the second media information, and identifies different schedule sections therebetween (S303). Here, the content schedule of the first media information or the second media information refers to information about display, playback or broadcasting time of content contained in each media information, and may include playback start and end times, a total playback time, etc. of the content. Further, the schedule section refers to a subordinate unit of the content schedule. In other words, the content schedule of the first or second media information may include at least one schedule section. For example, when each piece of the media information includes information about at least one piece of content, information about each piece of content may correspond to at least one schedule section. In this case, it is possible to identify the same schedule sections and different schedule sections by comparison in the content schedule between the first media information and the second media information, and thus the processor 260 identifies the different schedule sections in the content schedule.

Further, the processor 260 may obtain schedule information about service content about a broadcast program to be provided from a broadcast signal, based on the identified schedule section. Here, the service content include content having a correlation, for example, having a content or time correlation with a broadcast program to be provided from a broadcast signal. For example, the service content includes advertisement images reproduced before and after a broadcast program to be provided from a broadcast signal or in a middle of the broadcast program, various pieces of appended information related to the corresponding broadcast program, etc. However, the service content may include any piece of content without limitations as long as it is content having a correlation with a broadcast program provided from a broadcast signal. For convenience of description, it will be generally described below on the assumption that the service content is the advertisement.

Further, the schedule information of the service content refers to information about display, playback or broadcasting time of service content, and may include playback start and end times, a total playback time, etc. of the service content.

The processor 260 performs operations convenient for a user, which are related to use of a broadcast program, based on the identified schedule section (S304). Alternatively, the processor 260 may perform operations convenient for a user, which are related to use of a broadcast program, based on the schedule information about the obtained service content. Here, operations convenient for a user related to use of a broadcast program include all operations, which correspond to or meet a user's request, in relation to watching or using a predetermined broadcast program. For example, the operations include, but not limited to, a watching schedule of a predetermined broadcast program, a broadcasting start time guide of the broadcast program based on the watching schedule, scheduled recording of a predetermined broadcast program, playback, edition, etc. of the recorded broadcast program.

The foregoing operations mentioned in FIG. 3 will be described later in more detail.

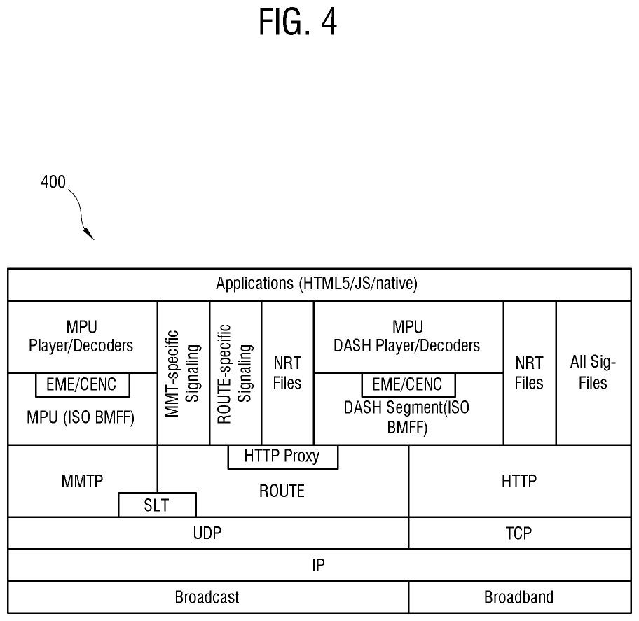

FIG. 4 is a block diagram showing a protocol stack based on ATSC 3.0, i.e., standards for a broadcast signal transmitted to a display apparatus according to an embodiment of the disclosure.

The protocol stack of FIG. 4 show protocols according to communication layers. In ATSC 3.0, a broadcast signal is transmitted by two modes of the broadcast and the broadband. The broadcast signal of the broadcast mode may be transmitted through a terrestrial channel by an MPEG Media transport protocol (MMTP) or a real time object delivery over Unidirectional transport (ROUTE) protocol. According to the MMTP protocol, media processing units (MPU) are transmitted by the MMTP, based on MPEG media transport (MMT). According to the ROUTE protocol, dynamic adaptive streaming over HTTP (DASH) segment is transmitted by the ROUTE, based on MPEG DASH. Content transmitted using the MMTP or ROUTE may be given in real time or non-real time (NRT). Such content may be played back by an MPU Player or a DASH Player.

The broadcast signal of the broadband mode is transmitted through the Internet by the HTTP. In this case, a DASH segment, signaling information, NRT and the like information is transmitted to by the HTTP. Such information is encapsulated in a link layer via a transmission control protocol (TCP) and an Internet protocol (IP) layer, subjected to a process for transmission in a physical layer, and then transmitted.

Signaling of ATSC 3.0 is divided into low-level signaling (LLS) transmitted through a previously assigned IP address and a user datagram protocol (UDP) port, and a service layer signaling (SLS) transmitted through the MMTP or ROUTE protocol. The information for obtaining the SLS is provided through a kind of the LLS, i.e., a service list table (SLT), and the SLT provides information about the protocols of the broadcast service according to which the SLS is transmitted in the physical layer and a transport layer. The processor of the broadcast receiving apparatus obtains the SLT and the SLS from the broadcast signal, thereby obtaining the signaling information of the broadcast service.

For example, when the first media information according to an embodiment of the disclosure includes the MPD and the service app includes the AD insertion app, the MPD may be transmitted as included in the SLS. The AD insertion app may be transmitted as an NRT object as one of objects transmitted based on the ROUTE protocol, and signaled by the information included in the SLS.

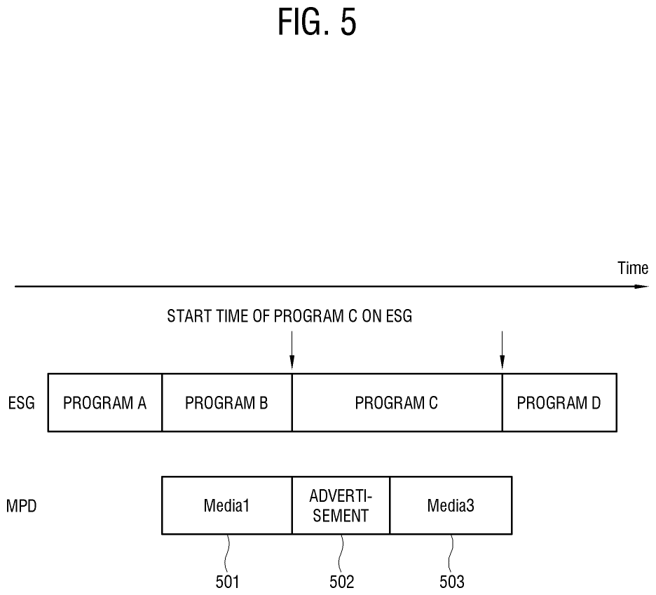

FIG. 5 illustrates a relationship between an electronic service guide (ESG) and an MPD.

Under ATSC 3.0, broadcasting companies provide schedule information of broadcast programs through ESG information. The ESG information is obtainable as the receiver 210 is tuned to a broadcast signal including the corresponding broadcast program. The schedule information of each broadcast program contained in the broadcast signal is obtained through the ESG information. In other words, as shown in FIG. 5, the start times and the end times of the broadcast programs A, B, C and D are obtained from the ESG information.

However, the ESG information does not contain service content about the corresponding broadcast program, for example, does not contain information about advertisement reproduced before, after or in a middle of the corresponding broadcast program. To provide the information about the advertisement, the broadcasting companies employ the MPD and the AD insertion app. Specifically, the broadcasting companies transmit the AD insertion app as the service app together with the broadcast signal to the display apparatus 100, so as to execute the AD insertion app through the display apparatus 100, generate a replacement MPD by replacing partial information of an original MPD into information about advertisement, and make the display apparatus 100 reproduce media, i.e., the broadcast program and the advertisement based on the replacement MPD, thereby providing the advertisement together with the broadcast program to viewers. In other words, as shown in FIG. 5, the replaced MPD contains not only image information 501 and 503 about a broadcast itself as content to be reproduced within a reproduction time of each broadcast program, but also information 502 about advertisement content to be reproduced in connection with the corresponding broadcast program.

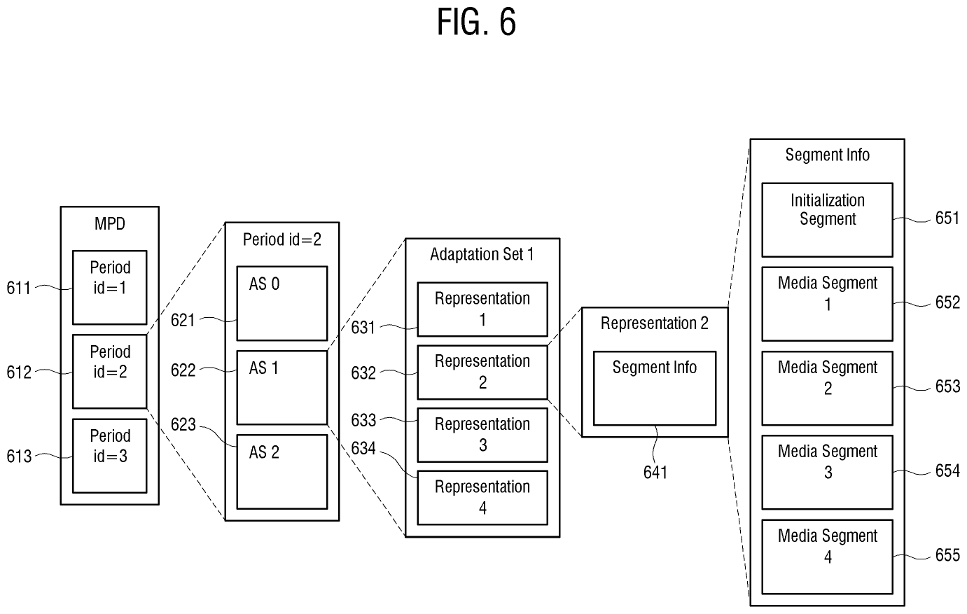

Below, it will be described with reference to FIGS. 6 to 13 that the replacement MPD is generated from the original MPD by the AD insertion app.

FIG. 6 illustrates a structure of an MPD. The MPD contains a sequence of content, and length information, a start time, segment information, etc. of each piece of content. The MPD includes periods Period 611-613 of defining sections on a time axis. The period includes adaptation sets As 621-623 including representations Representation 631-634 according to resolutions. The representations 631-634 of the adaptation sets 621-623 include segment information Segment Info 641. The segment information Segment Info 641 includes at least one media segment Media Segment 651-655. The media segments Media Segment 651-655 refer to information in which audio/video (AV) information such as an image, a sound, etc. is recorded in units of segments, and include the start times and segment filenames of the segments.

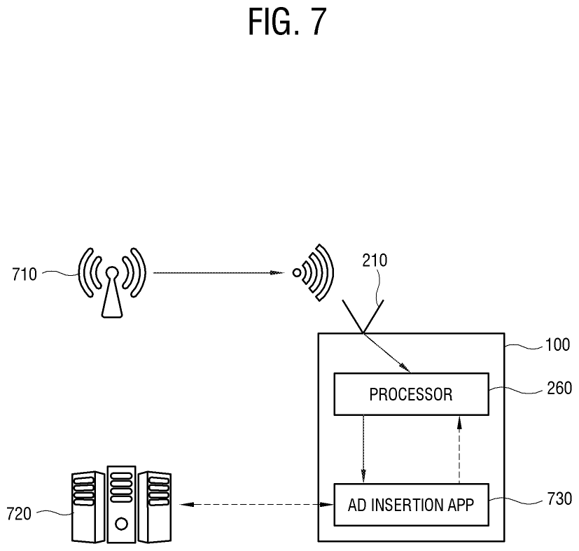

FIG. 7 illustrates a process and route of generating a replacement MPD from an original MPD by a display apparatus according to an embodiment of the disclosure.

The original MPD may be transmitted to the display apparatus 100 as included in a broadcast signal transmitted from a transmitter 710 of a first broadcast transmitting apparatus 110, for example, a broadcasting station in the broadcast mode. However, the original MPD may be transmitted through, but not limited to, a second broadcast transmitting apparatus 120 in the broadband mode, or through other routes.

When the original MPD is transmitted from the first broadcast transmitting apparatus 110, e.g., the transmitter 710 of the broadcasting station, the display apparatus 100 may receive the original MPD through the receiver 210. When the original MPD is received through the receiver 210, the processor 260 according to an embodiment of the disclosure executes an AD insertion app 730 to receive a replacement MPD corresponding to the original MPD from an advertisement server 720. Specifically, when the processor 260 makes the original MPD be transmitted to and processed by the AD insertion app 730, the AD insertion app 730 receives advertisement information corresponding to the original MPD from the advertisement server 720, generates the replacement MPD by replacing at least part of information of the original MPD into the advertisement information based on the received advertisement information, and transmits the generated replacement MPD to the processor 260. In other words, the processor 260 transmits the original MPD to the AD insertion app 730, and then receives the replacement MPD from the AD insertion app 730. For convenience of description, FIG. 7 divisionally shows the processor 260 and the AD insertion app 730 as separated elements, but the disclosure is not limited thereto. For example, the AD insertion app 730 may substantially operate inside the processor 260, or may operate other apparatuses than the display apparatus 100.

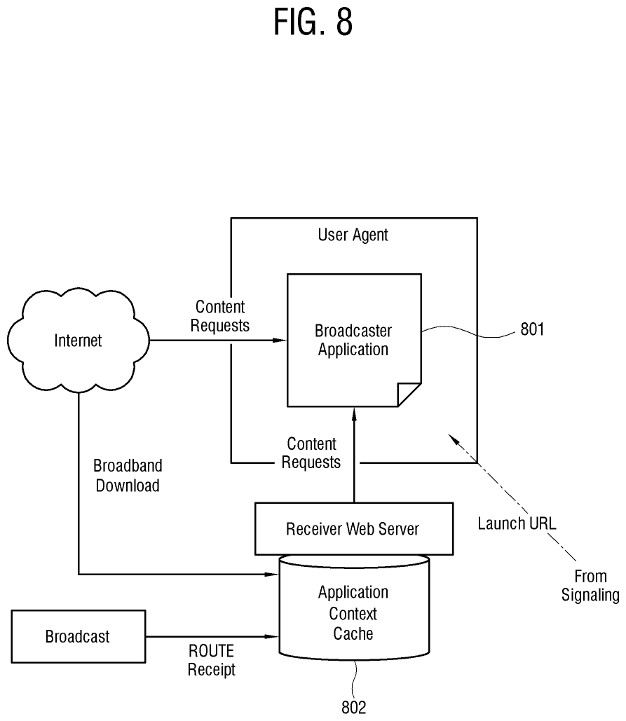

FIG. 8 is a schematic operation view of an AD insertion app in a display apparatus 100 according to an embodiment of the disclosure. The AD insertion app is a kind of broadcaster application 801, which is a web application sent by the broadcasting company. The AD insertion app may be stored in the storage 250 or the memory of the display apparatus 100, for example, in a region of an application context cache 802. The broadcaster application operates using broadcast or broadband resources, and the AD insertion app receives information about what advertisement will be selected for a corresponding target from an AD decision server 720 on the Internet, processes this information in the form of the MPD, and transmits the processed information to the display apparatus 100.

The AD insertion app may be provided according to the broadcasting companies or content providers. In this case, there are various methods and timings of loading and unloading the AD insertion app to and from the memory of the display apparatus 100. For example, the processor 260 of the display apparatus 100 receives the AD insertion app provided by a predetermined broadcasting company when tuned to the broadcast of the corresponding broadcasting company for the first time, and then uses the received AD insertion app being continuously loaded to the memory on the display apparatus 100. Alternatively, the processor 260 may make the AD insertion app be not continuously loaded to the memory but unloaded from the memory when stopped from being tuned to the broadcasting company. Alternatively, the processor 260 may identify whether the function of inserting AD information is further needed for the MPD of the corresponding broadcasting company instead of immediately unloading the AD insertion app from the memory every time when the tuning is released, and then unload the AD insertion app from the memory when it is identified that the function is not needed.

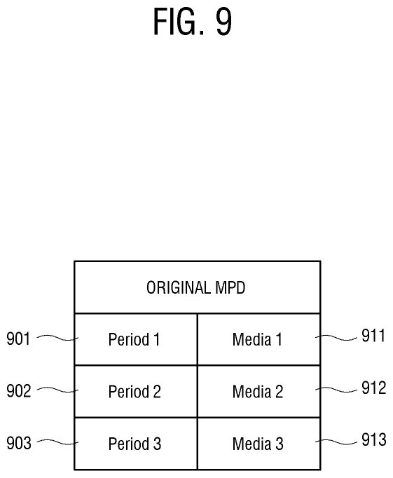

FIGS. 9 to 12 illustrate examples of the original MPD and the replacement MPD.

FIG. 9 schematically shows the original MPD. In FIG. 9, the original MPD includes three periods 901-903, and the periods respectively include corresponding media information 911-913. Each of the periods 901-903 may include information about time corresponding to the period. For example, each of the periods 901-903 may include information about a start time and time duration of the corresponding period, or information about the start time and end time of the corresponding period. The media information 911-913 may include information about media to be reproduced corresponding to the periods 901-903. For example, the media information 911-913 may include the kinds (e.g., a moving picture, a still image, etc.), formats (e.g., ‘mpeg,’ ‘avi,’ ‘jpeg,’ etc.), address (e.g., uniform resource locator (URL), uniform resource identifier (URI), etc.), etc. of media to be reproduced.

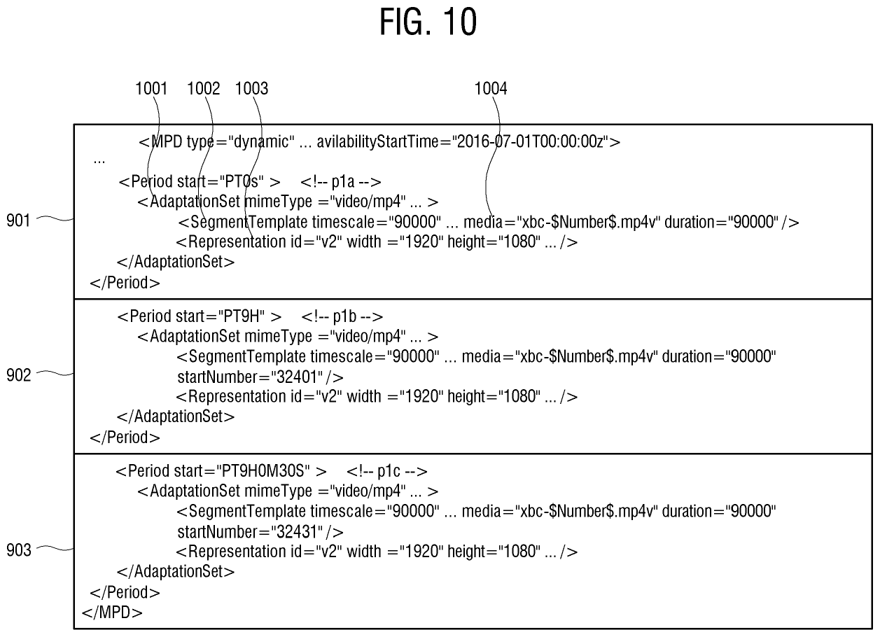

FIG. 10 shows details of the original MPD shown in FIG. 9. Each of the periods 901-903 includes a tag (e.g., start) indicating the start time of the corresponding period, and a value (e.g., 0 s, 9 h, 9 h0 m30 s, etc.) assigned to the tag. Each of the periods 901-903 includes an adaptation set 1001, and the adaptation set 1001 is set with a predetermined tag (e.g., mimeType) and a value (e.g., video/mp4) assigned to the tag. The adaptation set 1001 includes segment information 1002 and representation information 1003. The segment information 1002 includes many tags and values assigned to the tags. For example, in the segment information 1002, address information about a media segment corresponding to the segment is set with a media tag 1004. Even in the representation information 1003, various tags (e.g., id, width, height) are set with assigned values

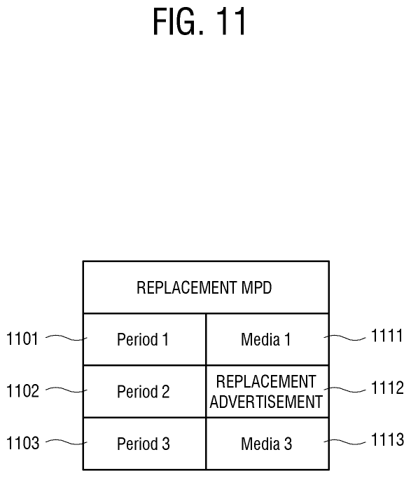

FIG. 11 schematically shows the replacement MPD created from the original MPD by the AD insertion app. The replacement MPD in FIG. 11 includes three periods 1101-1103, and the periods respectively include corresponding pieces of media information 1111-1113. Each of the periods 1101-1103 in the replacement MPD of FIG. 11 may include information about time of the corresponding period, like the periods 901-903 of FIG. 9. For example, each of the periods 1101-1103 may include information about a start time and time duration of the corresponding period, or information about the start time and end time of the corresponding period. The media information 911-913 may include information about media to be reproduced corresponding to the periods 901-903. The media information 1111-1113 of the replacement MPD of FIG. 11 may include information about media to be reproduced corresponding to the periods 1101-1103, like the media information 911-913 of FIG. 9. For example, the media information 1111-1113 may include the kinds (e.g., a moving picture, a still image, etc.), formats (e.g., ‘mpeg,’ ‘avi,’ ‘jpeg,’ etc.), address (e.g., URL, URI, etc.), etc. of media to be reproduced.

As compared with FIG. 9, FIG. 11 shows that not Media2 912 but replacement advertisement 1112 is set as the media information corresponding to the second period 1102. In other words, the replacement MPD of FIG. 11 is an MPD generated by replacing the existing information of the media information corresponding to the second period in the original MPD of FIG. 9 into advertise information. Therefore, the processor 260 can obtain schedule information about advertisement by comparing the original MPD of FIG. 9 and the replacement MPD of FIG. 11. Specifically, it is identified based on the comparison between the original MPD of FIG. 9 and the replacement MPD of FIG. 11 that media to be reproduced corresponding to the same periods 902 and 1102 are different, in particular, that the media to be reproduced corresponding to the same periods 902 and 1102 are different in the URL or the like address, and therefore the processor 260 can identify that the media information corresponding to the period 1102 of the replacement MPD is the advertisement information, and identify the time information or schedule information corresponding to the advertisement information from the time information about the corresponding period 1102.

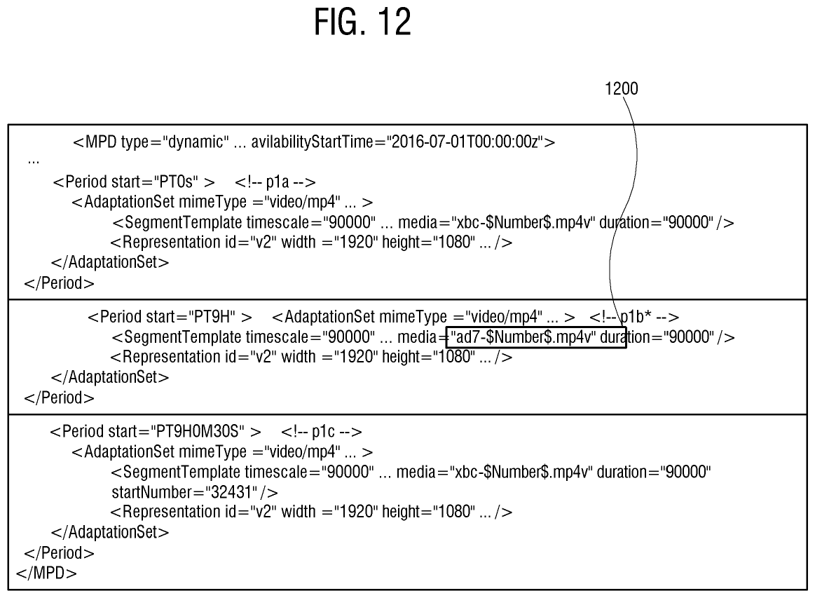

FIG. 12 shows details of the replacement MPD shown in FIG. 11. As compared with FIG. 10 showing the details of the original MPD, content is not changed except that a value 1200 corresponding to the media tag of the second period is changed from “xbc-$number$.mp4v” of FIG. 10 into “ad7-$number$.mp4v.”

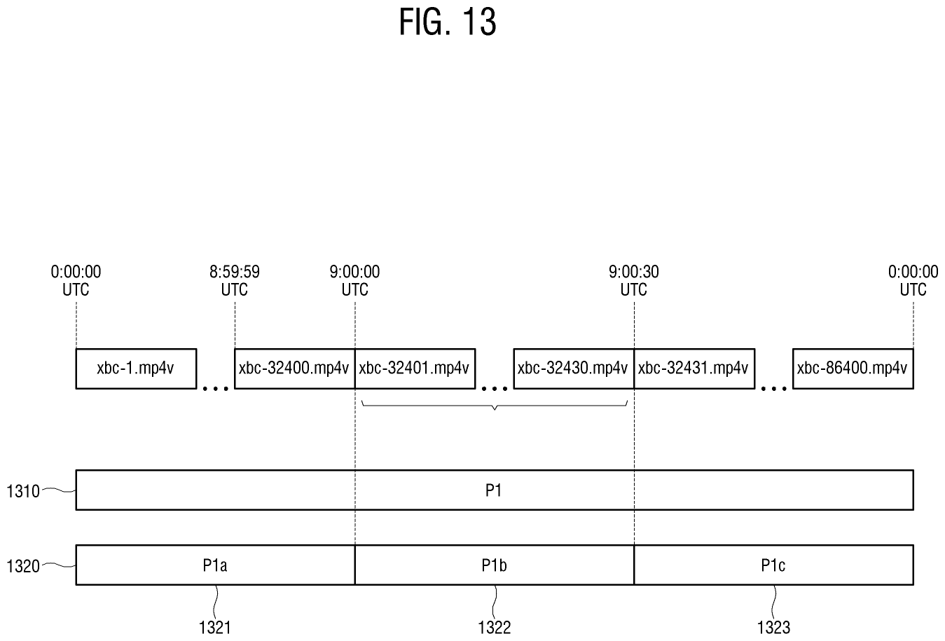

FIG. 13 illustrates a playback sequence or a playback flow of content based on media information of an original MPD and a replacement MPD.

The processor 260 of the display apparatus 100 reproduces content with reference to the MPD information. Specifically, the processor 260 checks the period corresponding to the current time in the MPD information and reproduces the corresponding media file. For example, when the processor 260 of the display apparatus 100 references to an original MPD 1310, the display 230 sequentially displays media files corresponding to the periods, such as ‘xbc-1.mp4v’, ‘xbc-32400.mp4v’, ‘xbc-32401.mp4v’ and ‘xbc-32431.mp4v’ at reproduction times of 0:00:00 UTC, 8:59:59 UTC, 9:00:00 UTC, 9:00:30 UTC, respectively, as time goes on.

On the other hand, the processor 260 of the display apparatus 100 references a replacement MPD 1320, the display 230 sequentially displays ‘xbc-1.mp4v’ and ‘xbc-32400.mp4v’ as the media files corresponding to the first period 1321 like the original MPD 1310, but displays content, which is different from that of when the original MPD is referenced, in a time corresponding to the second period 1322 because the information about the media file corresponding to the second period 1322 is changed. Then, when content is displayed with reference to a third period 1323, the same content as that of when the original MPD is referenced is displayed. This is because the advertisement information is not inserted or replaced in the original MPD corresponding to the third period 1323.

As described above, the replacement MPD, which is obtained by replacing at least part of information about the original MPD with information about advertisement, and thus the processor 260 of the display apparatus 100 processes a broadcast program and the advertisement corresponding to the broadcast program to be displayed based on the replacement MPD on the display 230. However, while the processor 260 displays the content based on the MPD on the display 230, the processor 260 can display an image corresponding to the media information on the display 230 with reference to the media information corresponding to the periods, but cannot identify whether the kinds of media information corresponding to the periods is advertisement or not. This is because the processor 260 just manually reproduces a media file along a link of the MPD and does not identify the kinds of image corresponding to the periods or segments. In other words, even though the original MPD is replaced by the replacement MPD, only the replacement MPD is not enough to identify the advertisement schedule.

To obtain schedule information about advertisement or the like service content of a broadcast program, the processor 260 of the display apparatus 100 according to an embodiment of the disclosure obtains the schedule information about the service content based on first media information and second media information.

As an example of a method of obtaining the schedule information about the service content based on the first media information and the second media information, the processor 260 of the display apparatus 100 according to an embodiment of the disclosure may obtain the schedule information about the service content based on comparison between the first media information and the second media information. Specifically, as described above with reference to FIGS. 9 and 11, the processor 260 may identify a different schedule section by comparison in the content schedule between the first media information and the second media information, and obtain the schedule information about the service content related to the broadcast program to be provided from the broadcast signal based on the identified different schedule section. For example, when the first and second media information is the MPD and the service content is the advertisement, the processor 260 may obtain the schedule information of the advertisement by comparison between the original MPD and the replacement MPD. Because the replacement MPD is the MPD obtained as the AD insertion app replaces at least part of the original MPD with the advertisement information, it is possible to identify that a section contains the advertisement information when the section of different content is identified by comparison between the original MPD and the replacement MPD, and obtain the schedule information of the advertisement section by checking reproduction information of the corresponding section, for example, a reproduction start time, a reproduction end time, a total reproduction time, etc.

Thus, it is possible to quickly and easily obtain the schedule information of the service content related to the broadcast program.

As an alternative example of the method of obtaining the schedule information about the service content based on the first media information and the second media information, the processor 260 of the display apparatus 100 according to an embodiment of the disclosure may obtain the schedule information about the service content based on the comparison between the original MPD and the replacement MPD in units of period. In other words, in terms of the comparison between the original MPD and the replacement MPD, the processor 260 performs the comparison in units of period. Because the AD insertion app replaces the information of the original MPD by the advertisement information in units of period, it is efficient to perform comparison in units of period in terms of the comparison between the original MPD and the replacement MPD.

Thus, it is possible to more quickly obtain the schedule information of the service content related to the broadcast program.

As an alternative example of obtaining the schedule information of the service content based on the first media information and the second media information, the processor 260 of the display apparatus 100 according to an embodiment of the disclosure may obtain the schedule information of the service content by comparison in the media tag of the segment that belongs to each period of the MPD. As described above with reference to FIG. 12, different part between the original MPD and the replacement MPD may be only the media tag of the segment included in the period. In this case, by the comparison in only the media tag of the segment between the original MPD and the replacement MPD, it is possible to preferentially and quickly identify what period has the replacement with the advertisement information, and then check production information of the corresponding period, for example, a reproduction start time, a reproduction end time, a total reproduction time, etc., thereby obtaining the schedule information of the advertisement part.

Thus, it is possible to more quickly obtain the schedule information of the service content related to the broadcast program.

The processor 260, which obtains the schedule information of the service content related to the broadcast program by one of the foregoing methods, may perform operations convenient for a user to use a broadcast program based on the obtained schedule information. Below, various embodiments, in which operations convenient for a user to use a broadcast program is performed based on the obtained schedule information, will be described.

As an example of performing operations convenient for a user to use a broadcast program based on the obtained schedule information, the processor 260 identifies a broadcast start time of the broadcast program provided after the service content is ended, and performs the operations convenient for a user based on the identified broadcast start time.

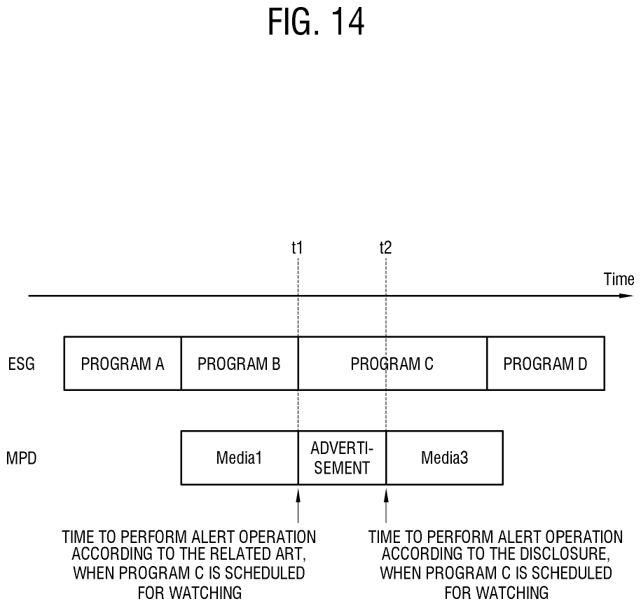

As an example of performing operations convenient for a user based on the identified broadcast start time, the processor 260 receives a user's input for a schedule for watching of a broadcast program, and display an alert message for a user on the display 230 based on the identified broadcast start time. Referring to FIG. 14, in case of a conventional operation of a schedule for watching a broadcast, for example, when a user makes a schedule for watching a broadcast corresponding to a program C, the processor 260 of the display apparatus 100 displays a message to inform a user of that the broadcast of the program C will begin soon at a start time t1 of the program C given on the ESG or a little earlier than the start time t1. However, not the program C but the advertisement reproduced before broadcasting the program C is actually broadcasted at the time t1, and therefore a user cannot immediately watch the program C even though the user changes a channel to that for the program C in response to the alert message but has to wait until the advertisement is ended.

On the other hand, in case of an operation of a schedule for watching a broadcast according to the disclosure, for example, when a user makes a schedule for watching a broadcast corresponding to the program C, the processor 260 of the display apparatus 100 identifies that the advertisement starts at the start time t1 of the program C given on the ESG and ends at a time t2, based on the schedule information obtained with regard to the advertisement, and then displays a message to inform a user of that the broadcast of the program C will begin soon not at the start time t1 of the program C given on the ESG but at the actual start time t2 of the program C or a little earlier than the start time t2.

Accordingly, in terms of providing a watching schedule function for a predetermined broadcast program, an alert message is displayed after advertisement reproduced before a broadcast program starts is ended, and therefore it is convenient for a user because the user does not have to watch undesired advertisement or repetitively change a channel to avoid watching the undesired advertisement.

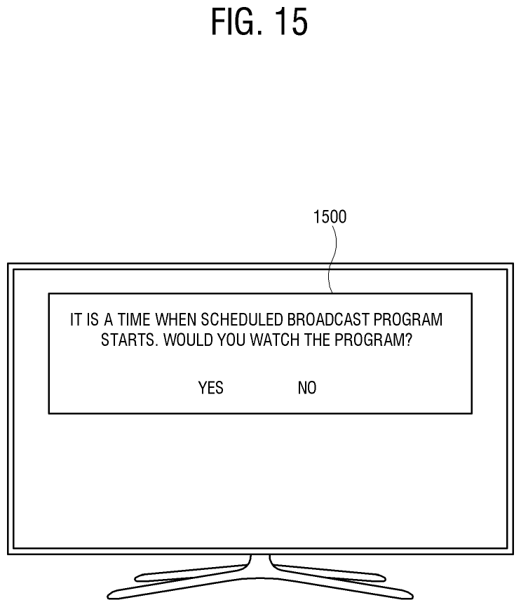

In terms of a user interface (UI), difference between the related art and the disclosure in the foregoing embodiment will be described with reference to FIGS. 15 to 19.

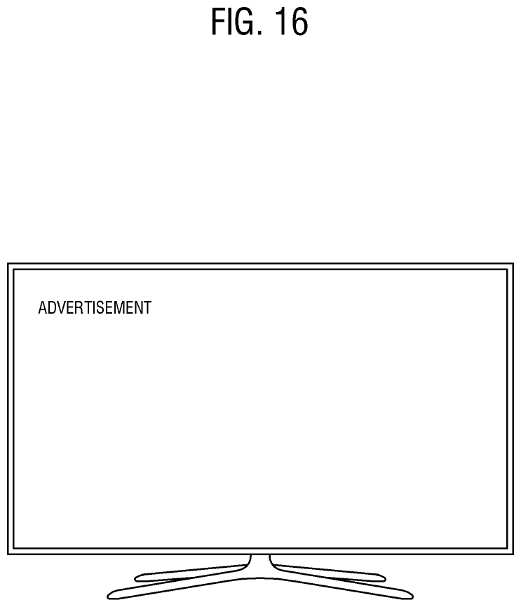

When a predetermined program, for example, the program C is scheduled by a user, the processor 260 of the display apparatus 100 according to the related art displays a UI menu 1500, which informs that the scheduled broadcast program will begin soon, on the display 230 at the start time of the program C given on the ESG. When a user makes selection to watch the scheduled program based on the displayed UI menu 1500, the program C does not start yet at that time but the advertisement is being reproduced in the related art. Therefore, even though a channel change is made for the program C based on a user's watching selection, it is inconvenient for a user because the advertisement is being still reproduced in the corresponding channel as shown in FIG. 16.

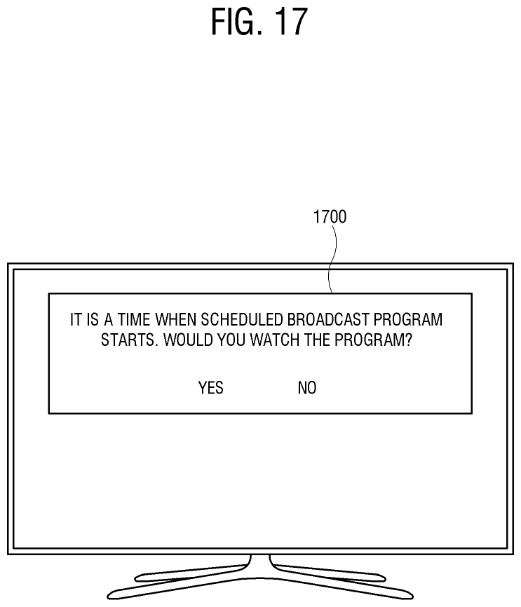

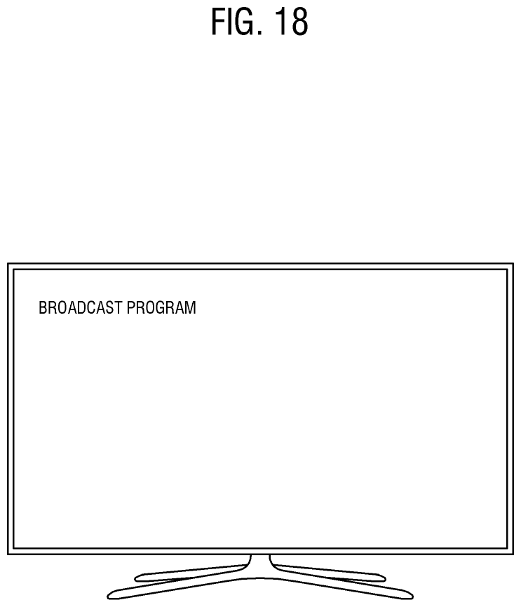

On the other hand, the processor 260 of the display apparatus 100 according to the disclosure display a UI menu 1700, which informs the scheduled broadcast program will begin soon, as shown in FIG. 17, at a time elapsed as much as the advertisement reproduction time from the start time of the program C given on the ESG, i.e., at a time when the advertisement is ended or a time a little earlier than that time. Therefore, when a user makes selection for watching the scheduled program based on the displayed UI menu 1700, according to the disclosure it is possible to make a channel change for the scheduled program at the time when the program C is substantially broadcasted after the advertisement is ended on the contrary to the related art in which the advertisement is being reproduced and the program C does not start yet at that time. Therefore, as shown in FIG. 18, it is possible to watch the scheduled broadcast program immediately after the channel change.

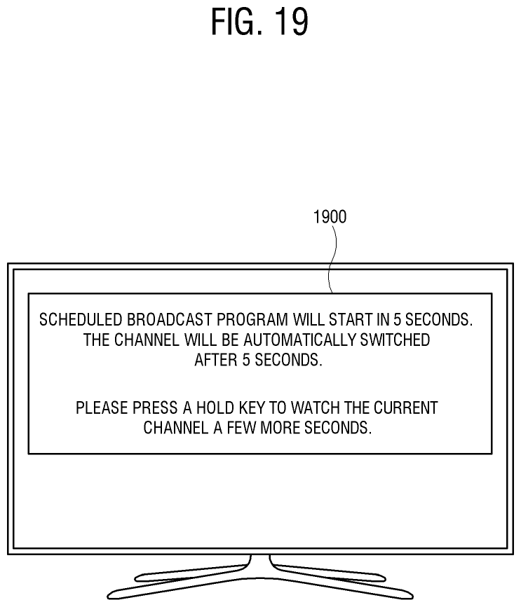

Meanwhile, the foregoing embodiment shows an example that the channel change is made for the scheduled broadcast program based on a user's input corresponding to the UI which informs that it becomes time when the scheduled program starts after the watching is scheduled, but the disclosure is not limited to this embodiment. Alternatively, when it becomes time when the scheduled program starts after the watching is scheduled, the processor 260 may automatically switch over to a scheduled channel without receiving a user's additional input. Further, in terms of automatically switching over to the scheduled channel, the processor 260 may display a guide UI 1900, which guides a user to press a predetermined key if the user wants to delay the automatic channel change for a predetermined period of time, as shown in FIG. 19, thereby providing a function of allowing a user to intentionally delay the automatic channel change when the user wants to watch the currently watching broadcast program for only a few more seconds.

Thus, convenience for a user is further improved.

As an alternative example of performing operations convenient for a user to use a broadcast program based on the obtained schedule information, the processor 260 may receive a user's input for scheduling recording of the broadcast program, and perform a recording operation for the broadcast program by switching the display apparatus 100 over from a sleep mode to a recording mode based on an identified broadcast start time. In other words, according to an embodiment, when a user makes an input so that the display apparatus 100 can perform a scheduled recording function with regard to a predetermined program, the display apparatus 100 is not completely turned off even though the user turns off the display apparatus 100 but operates in the sleep mode in which the display apparatus 100 is on standby to be waken up in the future with the minimum power. Thereafter, when it becomes the start time of the program targeted for the scheduled recording, the display apparatus 100 wakes up and switches over to the recording mode, thereby carrying out the scheduled recording operation. Here, the recording mode may include any state of the display apparatus 100 without limitations as long as it allows the recording operation to be performed with respect to the broadcast program.

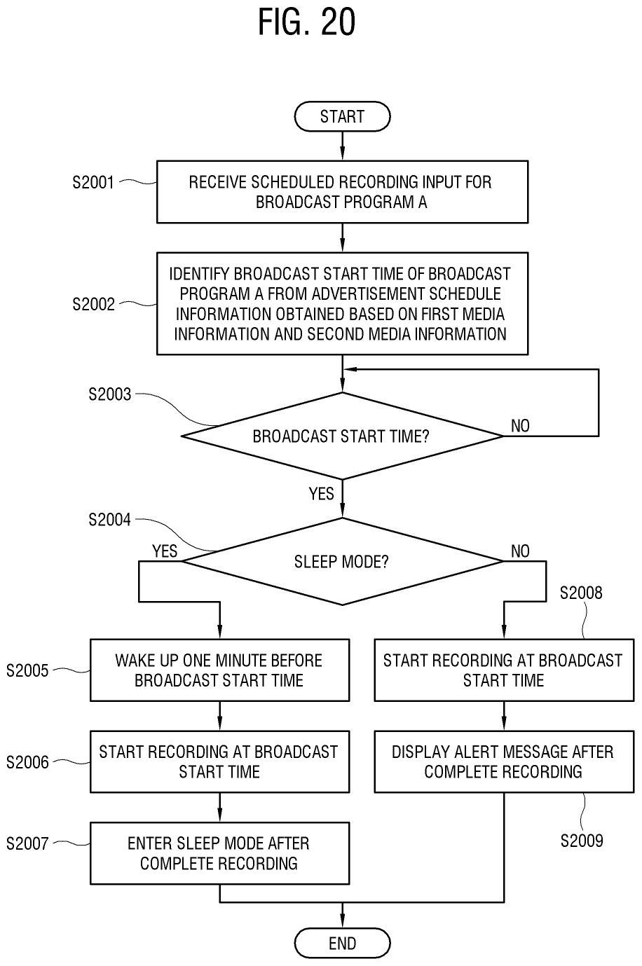

This embodiment will be described in detail with reference to FIG. 20. The processor 260 of the display apparatus 100 according to this embodiment receives a scheduled recording input for a predetermined broadcast program, for example, a broadcast program A from a user (S2001), and identifies a broadcast start time of the broadcast program A from advertisement schedule information obtained based on the first media information and the second media information (S2002). Thereafter, when it becomes the broadcast start time of the broadcast program A (S2003), the processor 260 checks whether the display apparatus 100 is in the sleep mode (S2004). When the display apparatus 100 is in the sleep mode, the processor 260 makes the display apparatus 100 be waken up one minute before the broadcast start time of the broadcast program. A and enter the recording mode (S2005), and starts recording the recording-scheduled broadcast program A in the broadcast start time (S2006). Although the foregoing embodiment shows an example that the display apparatus 100 is waken up from the sleep mode one minute before the broadcast start time, there are no limits to the waking-up time as long as it is earlier than the broadcast start time. After the broadcast program A is completely recorded, the processor 260 may make the display apparatus 100 return to the sleep mode (S2007). Meanwhile, when it becomes the broadcast start time of the broadcast program A (S2003) but the display apparatus 100 is not in the sleep mode (S2004), the processor 260 can immediately start recording the broadcast program A at the broadcast start time of the broadcast program A without changing the operation mode of the display apparatus 100 (S2008). Thereafter, when the recording is completed, the processor 260 may display the alert message, which informs that the recording is completed, on the display 230 (S2009).

Meanwhile, regarding the scheduled recording function for a predetermined broadcast program, a processor of the display apparatus 100 according to another embodiment of the disclosure may perform the scheduled recording with regard to the broadcast program except the service content, in response to a user's input for scheduled recording of the broadcast program.

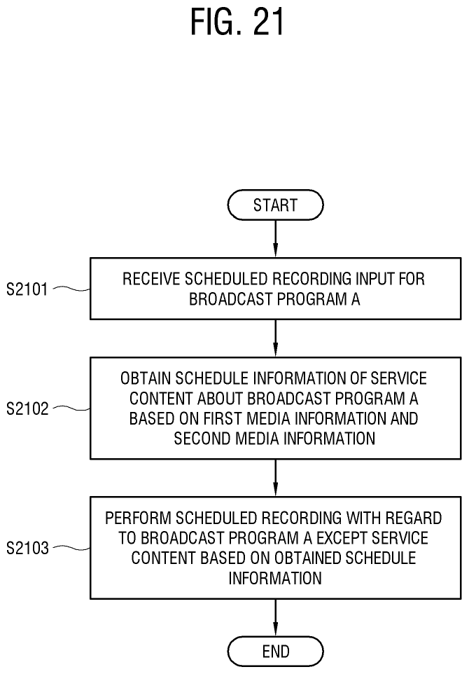

This will be described in detail with reference to FIG. 21. The processor 260 of the display apparatus 100 according to an embodiment receives a scheduled recording input for the broadcast program A from a user (S2101), obtains the schedule information of the service content about the broadcast program A based on the first media information and the second media information (S2102), and performs the scheduled recording with regard to the broadcast program A except the service content based on the obtained schedule information (S2103). For example, when the first media information and the first media information are the original MPD and the replacement MPD, respectively, the processor 260 can obtain the schedule information of the advertisement about the broadcast program A by the comparison between the original MPD and the replacement MPD as described above in the foregoing embodiments, and thus record only the broadcast program A other than the advertisement without recording the advertisement, based on the obtained advertisement schedule information, in terms of performing the scheduled recording for the broadcast program. A. In this case, the advertisement may be reproduced before, after or in a middle of the broadcast program A, and the processor 260 according to an embodiment can record the broadcast program A except the advertisement regardless of the reproduction time of the advertisement.

Thus, convenience for a user is further improved.

As an alternative example of performing operations convenient for a user to use a broadcast program based on obtained schedule information, the processor 260 may display customized content for a user of the display apparatus, which replaces the service content, based on the obtained schedule information of the service content.

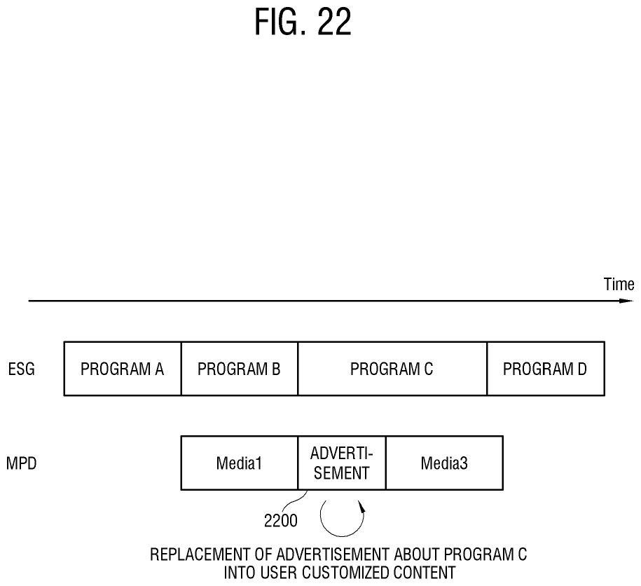

This will be described with reference to FIG. 22. As described above in the foregoing embodiments, according to the disclosure it is possible to obtain the schedule information of the service content about the broadcast program. For example, when the ESG and MPD information is the same as shown in FIG. 22, the processor 260 can obtain schedule information of advertisement 2200 in connection with a program C. According to this embodiment, the advertisement 2200 is replaced by user customized content and then the user customized content is displayed in a time for reproducing the advertisement, based on the obtained schedule information of the advertisement 2200. Here, the user customized content may include any content as long as it suits a user's tastes identified based on the user's viewing history related to the display apparatus 100, content use or purchase histories, user-input control content, etc. or is recommended by the user. As an example of a method of replacing the advertisement 2200 by the user customized content, the processor 260 may set advertisement part identified based on comparison between the original MPD and the replacement MPD, in other words, the media tag of the segment identified as the advertisement part in the replacement MPD into a link address of the user customized content. However, there are no limits to the method of replacing the advertisement by the user customized content.

1. A display apparatus comprising:
a receiver;
a communicator;
a display; and
a processor configured to:
obtain first media information and a service app from a broadcast signal received through the receiver,
receive second media information corresponding to the first media information from a server through the communicator by executing the obtained service app,
identify a different schedule section based on comparison in between content schedule of the first media information and content schedule of the second media information, and
perform an operation convenient for a user to use the broadcast program, based on the identified schedule section.

2. The display apparatus according to claim 1, wherein the first media information and the second media information comprises a media presentation descriptor (MPD).

3. The display apparatus according to claim 1, wherein the processor is configured to obtain schedule information of service content about a broadcast program to be provided from the broadcast signal, based on the identified schedule section.

4. The display apparatus according to claim 3, wherein the processor is configured to obtain the schedule information of the service content by comparing the MPD of the first media information and the MPD of the second media information in units of period.

5. The display apparatus according to claim 4, wherein the processor is configured to obtain the schedule information of the service content based on comparison in a media tag of a segment included in the period.

6. The display apparatus according to claim 3, wherein the processor is configured to identify a broadcast start time of a broadcast program provided after the service content is ended, based on the obtained schedule information of the service content, and perform the operation convenient for a user based on the identified broadcast start time.

7. The display apparatus according to claim 6, wherein the processor is configured to receive a user's input for making a schedule to watch the broadcast program, and display an alert message to the user on the display based on the identified broadcast start time.

8. The display apparatus according to claim 6, wherein the processor is configured to receive a user's input for making a schedule to record the broadcast program, switch the display apparatus over from a sleep mode to a recording mode based on the identified broadcast start time, and perform a recording operation for the broadcast program.

9. The display apparatus according to claim 3, wherein the processor is configured to perform scheduled recording for the broadcast program except the service content, based on a user's input for making a schedule to record the broadcast program.

10. The display apparatus according to claim 3, wherein the processor is configured to display customized content for a user of the display apparatus by replacing the service content based on the obtained schedule information of the service content.

11. A method of controlling a display apparatus, comprising:
obtaining first media information and a service app from a broadcast signal received through a receiver;
receiving second media information corresponding to the first media information from a server through a communicator by executing the obtained service app;
identifying a different schedule section based on comparison in between content schedule of the first media information and content schedule of the second media information; and
performing an operation convenient for a user to use the broadcast program, based on the identified schedule section.

12. The method according to claim 11, wherein the first media information and the second media information comprises a media presentation descriptor (MPD).

13. The method according to claim 12, further comprising obtaining schedule information of service content about a broadcast program to be provided from the broadcast signal, based on the identified schedule section.

14. The method according to claim 13, wherein the performing the operation convenient for a user comprises identifying a broadcast start time of a broadcast program provided after the service content is ended, based on the obtained schedule information of the service content, and performing the operation convenient for a user based on the identified broadcast start time.

15. A non-transitory computer readable medium storing a computer program to perform the method according to claim 11.
